(19) United States
(12) Patent Application Publication
(10) Pub. No.: US 2015/0115617 A1
(43) Pub. Date: Apr. 30, 2015

(54) APPARATUS AND METHOD FOR WIRELESSLY TRANSMITTING DATA FROM A VEHICLE LATCH

(71) Applicants: Andrew Powell, HALESOWEN (GB); Sean D. Williams, Broughton Astley (GB); Stephen Crisp, Yardley (GB); Steven Wilkes, PELSALL (GB); Martin Harvey, KINGSWINFORD (GB)

(72) Inventors: Andrew Powell, HALESOWEN (GB); Sean D. Williams, Broughton Astley (GB); Stephen Crisp, Yardley (GB); Steven Wilkes, PELSALL (GB); Martin Harvey, KINGSWINFORD (GB)

(21) Appl. No.: 14/528,273

(22) Filed: Oct. 30, 2014

Related U.S. Application Data
(60) Provisional application No. 61/897,905, filed on Oct. 31, 2013.

(51) Int. Cl. E05B 81/64; E05B 81/14

(52) U.S. Cl. CPC E05B 81/64; E05B 81/14
USPC 292/117

(57) ABSTRACT

A latch for a vehicle is disclosed herein. The latch including: a housing; a switch located within the housing, wherein the wireless switch is configured to only wirelessly transfer data from the housing, wherein the data corresponds to an operational state of the wireless switch, wherein the power required to wirelessly transfer the data from housing is generated solely by manipulation of an actuation member of the wireless switch; and a component moveably mounted within the housing for movement between at least a first position and a second position, wherein movement of the component in the housing manipulates the actuation member of the wireless switch and thus changes the state of the wireless switch.

### CROSS REFERENCE TO RELATED APPLICATIONS

This application claims the benefit of U.S. Provisional Patent Application Ser. No. 61/897,905 filed Oct. 31, 2013 the contents of which are incorporated herein by reference thereto.

### BACKGROUND

Various embodiments of the present invention are directed to an apparatus and method for wirelessly transmitting data from a vehicle latch.

Most vehicles have a door latch assembly that is a combination of a mechanical system and an electrical system. The primary function of the mechanical system is to keep the vehicle door closed and locked while also providing a means for opening or unlocking the door. The primary function of the electrical system in the latch is to provide a signal or signals to a control unit or controller wherein the signals are indicative of any one of a number of various positional elements of the latching system including but not limited to the vehicle's door position and locking and latching status of the mechanical system. These signals are provided by sensors or switches located through the latch assembly.

Depending on the number of sensors or switches located within the latch assembly electrical traces are required to allow for the signals of the switches or sensors to be communicated to the control unit or other sensors.

Adding numerous traces for the various switches and sensors of the latch adds to the complexity and cost of the same.

Accordingly, it is desirable to provide a door latch assembly with a plurality of sensors or switches that are able to communicate with the controller without adversely impacting the cost of the latch assembly and/or the construction of the latch housing.

### SUMMARY

In one embodiment, a latch for a vehicle is provided. A latch for a vehicle is disclosed herein. The latch including: a housing; a wireless switch located within the housing, wherein the wireless switch is configured to only wirelessly transfer data from the housing, wherein the data corresponds to an operational state of the wireless switch, wherein the power required to wirelessly transfer the data from housing is generated solely by manipulation of an actuation member of the wireless switch; and a component moveably mounted within the housing for movement between at least a first position and a second position, wherein movement of the component in the housing manipulates the actuation member of the wireless switch and thus changes the state of the wireless switch.

In another embodiment, a latch for a vehicle is provided. The latch including: a housing; a plurality of wireless switches located within the housing, wherein each of the plurality of wireless switches are located within the housing and are configured to independently wirelessly transmit data from the housing, wherein the data corresponds to the state of the wireless switch transmitting the data; wherein the power required to wirelessly transmit the data from housing is generated solely by manipulation of an actuation member of one the plurality of wireless switches; and a plurality of components moveably mounted within the housing for movement between at least a first position and a second position, wherein movement of at least one of the plurality of components in the housing manipulates the actuation member of at least one of the plurality of wireless switches and thus changes its state and causes data to be wirelessly transmitted from the housing of latch.

In yet another embodiment, a method for wirelessly transmitting the operational state of a plurality of components of a latch for a vehicle is provided. The method including the steps of: locating a plurality of wireless switches within a housing of the latch, each of the plurality of wireless switches being proximate to one of a plurality of components movably received within a housing of the latch such that movement of any one of the plurality of components from a first position to a second position will change the operational state of one of the plurality of wireless switches by manipulating an actuation member of the one of the plurality of wireless switches; and wirelessly transmitting only data from the housing when the operational state of one of the plurality of wireless switches is changed, wherein the power required to wirelessly transmit the data from housing is generated solely by manipulation of the actuation member of one the plurality of wireless switches.

The above described and other features are exemplified by the following figures and detailed description.

### DRAWINGS

Referring now to the FIGS., wherein exemplary embodiments are illustrated and like elements are numbered alike:

FIG. 1 is view of a latch;

FIG. 2 is a schematic illustration of wireless switch contemplated for use in the latch; and

FIG. 3 is a schematic illustration of a latch with a plurality of wireless switches and a plurality of movable components.

### DETAILED DESCRIPTION

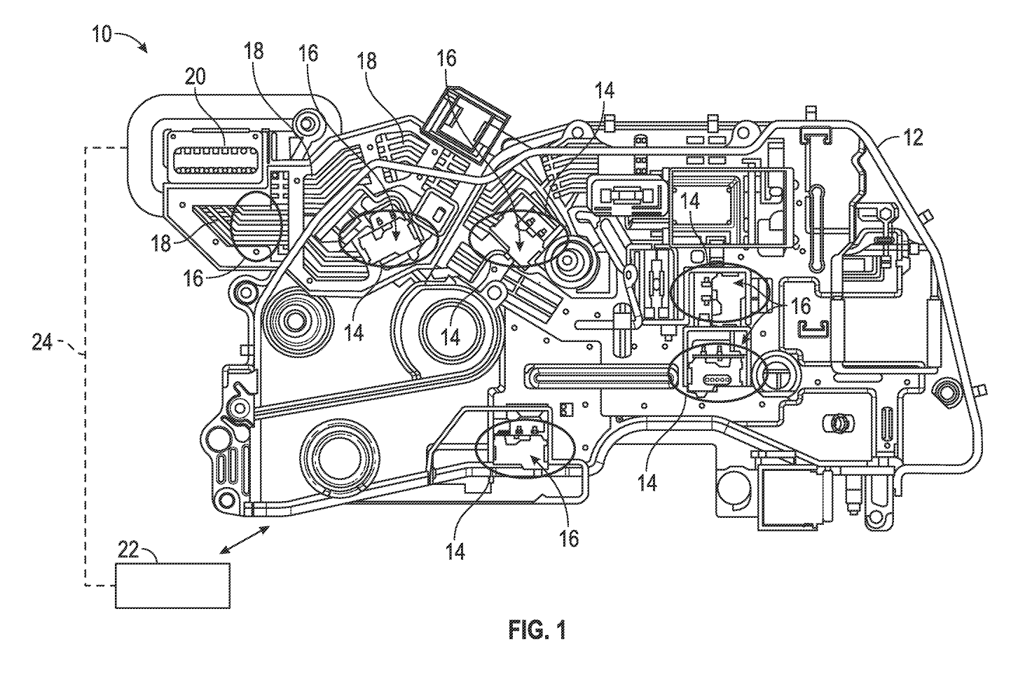

Referring now to FIG. 1 a vehicle latch 10 is illustrated. A vehicle latch may have a plurality of movable components capable of being positioned into a variety of positions and it is desirable to provide a signal or signals to a control unit or controller wherein the signals are indicative of any one of a number of various positional elements of the latching system including but not limited to the vehicle's door position and locking and latching status of mechanical components of the latch as well as electrical components of the latch. These signals are provided by a plurality of sensors or switches located through the housing 12 of the latch 10.

For example and referring now to FIG. 1 several locations 14 of switches 16 are illustrated. FIG. 1 shows a plurality of wire traces 18 that run through the housing 12 and are conductively connected to each one of the plurality of switches 16 and a terminal 20. These traces provide a means for electrical signals from the switches to be transmitted to a vehicle electronic controller or microcontroller 22 by for example a wiring harness 24.

These traces have to be stamped and formed to conform to the required housing configuration and are often overmoulded within the housing, which causes additional tooling costs.

In accordance with one embodiment of the present invention each of the plurality of switches 16 is replaced with a wireless switch hereinafter referred to as switch or wireless switch 16. By incorporating a plurality of wireless switches 16 into the latch 10 the aforementioned traces 18 can be eliminated. This would allow for a significant cost reduction in the latch 10 or latch housing 12. Also and if applicable, the wiring harness 24 may also be eliminated.

In one embodiment, the wireless switches 16 can be configured to communicate directly with the electronic controller or microcontroller 22. As mentioned above, this will allow for elimination of the wiring harness 24 or a significant portion of it in order to provide further cost savings.

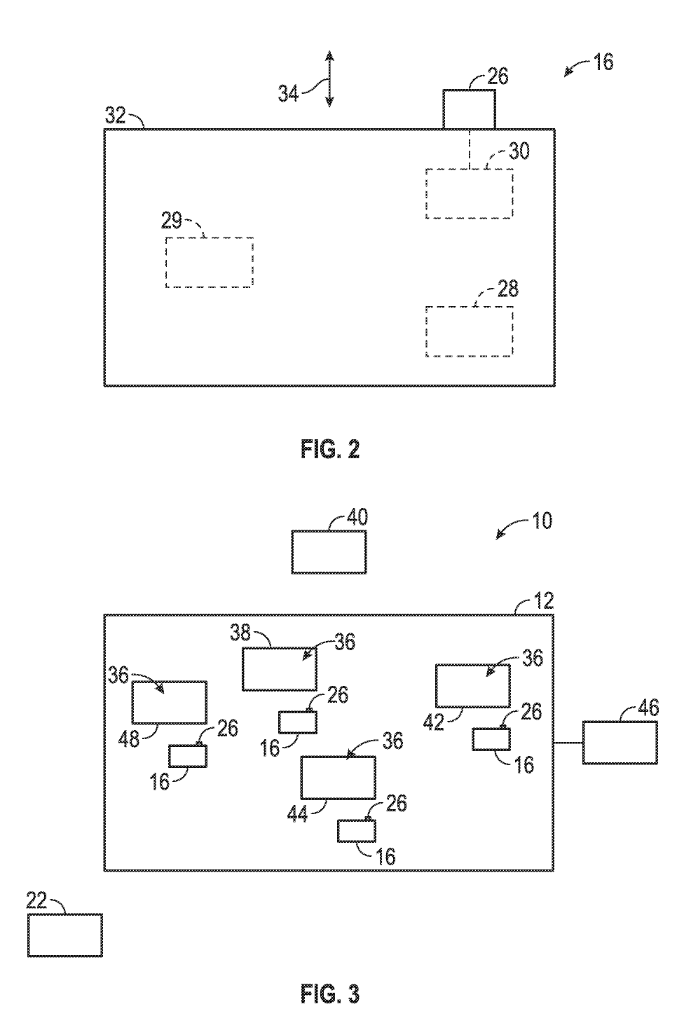

Referring now to FIGS. 1-3, a latch 10 for a vehicle is provided. The latch 10 has a housing 12. A least one wireless switch 16 is located within the housing 12. As mentioned above the wireless switch 16 is configured to only wirelessly transfer data from the housing, wherein the data corresponds to an operational state of the wireless switch. It is also understood that the wireless switch 16 may transfer data within the housing (e.g., to a microcontroller located within the housing 12) and/or within and out of the housing 12 either by the wireless switch 16 or a combination of the wireless switch 16 and the microcontroller or microprocessor. In one embodiment, the power required to wirelessly transfer the data from housing 12 is generated solely by manipulation of an actuation member 26 of the wireless switch 16.

In order to generate an induced voltage sufficient to wirelessly transmit a signal or data from the wireless switch 16, a coil 28 and magnetic member 30 are provided within a housing 32 of the wireless switch 16. Manipulation or up-and-down movement of actuation member 26 in the direction of arrows 34 will cause either or both the coil 28 and magnetic member 30 to move with respect to each other such that an induced voltage is generated solely via operation or movement of actuation member 26 that is operatively coupled to either one or both of the coil 28 and magnetic member 30. The wireless switch 16 will further comprise a wireless transmitter 29 configured to wirelessly transmit data for the operational state of the wireless switch (e.g., 0, 1) and the wireless transmitter 29 will be solely powered by the induced voltage generated by manipulation of the actuation member 26 of the wireless switch 16.

Operation of one contemplated wireless switch 16 is described in the following publications WO 2013/007474 and WO 2012/2097911, the contents each of which are incorporated herein by reference thereto. In addition, one type of commercially available wireless switch can be found at the following web site http://www.cherrycorp.com/english/switches/energy%20harvesting/index.htm under the title “energy harvesting wireless switch”. Accordingly, Applicant respectfully submits that operation of the wireless switch 16 would be known to those skilled in the related arts and embodiments of the present invention are directed to a vehicle latch 10 utilizing at least one or a plurality of wireless switches 16 in order to eliminate wire traces and if applicable and associated wiring harness 24 for the vehicle latch 10.

Referring now to FIG. 3, a component 36 or a plurality of components 36 is/are moveably mounted within the housing for movement between at least a first position and a second position, wherein movement of the component 36 in the housing 12 manipulates the actuation member 26 of the wireless switch 16 and thus changes the state of the wireless switch 16.

In one embodiment, the component 36 is a fork bolt 38 and the wireless switch 16 is located proximate to the fork bolt such that movement of the fork bolt between a latched and unlatched state will manipulate the actuation member and change the state of the wireless switch 16. In operation, the fork bolt 38 can be moved from the unlatched state to the latch state by a striker 40 configured to engage a portion of the fork bolt 38.

In another embodiment, the component 36 is a detent lever 42 configured to cooperate with the fork bolt 38 of the latch 10 and a wireless switch 16 is located proximate to the detent lever 42 such that movement of the detent lever 42 between an engaged position and disengaged position with respect to the fork bolt 38 will manipulate the actuation member 26 and change the state of the wireless switch 16. It is, of course, understood that a pair of wireless switches 16 may be used with the detent lever 42 and the fork bolt 38 or a single wireless switch 16 may be used only with either the detent lever 42 or the fork bolt 38.

In yet another embodiment, the component 36 is a child safety lever 44 configured to prevent the latch 10 from being opened by an inside release lever 46 associated with the latch 10 and a wireless switch 16 is located proximate to the child safety lever 44 such that movement of the child safety lever 44 between an engaged position and disengaged position will manipulate the actuation member 26 and change the state of the wireless switch. It is, of course, understood that a plurality of wireless switches 16 may be used with the child safety lever 44, the detent lever 40 and the fork bolt 38 or a single wireless switch 16 may be used only anyone of the child safety lever 44, the detent lever 40 or the fork bolt 38.

In yet another embodiment, the component 36 is a locking member 48 configured to lock and unlock the latch 10 and a wireless switch 16 is located proximate to the locking member 48 such that movement of the locking member 48 will manipulate the actuation member 26 and change the state of the wireless switch 16. It is, of course, understood that a plurality of wireless switches 16 may be used with the locking member 48, the child safety lever 44, the detent lever 40 and the fork bolt 38 or a single wireless switch 16 may be used only anyone of the locking member 48, the child safety lever 44, the detent lever 40 or the fork bolt 38.

Is also understood that while various specific components are mentioned above the embodiments of the present invention are not specifically limited to the components mentioned herein or combinations thereof as the latch 10 may incorporate numerous other movable components or actuators the position of which would be desirable to transmit via a wireless switch 16 to a controller a microcontroller of a system in which the latch 10 is incorporated.

In one embodiment, the data transmitted wirelessly from the wireless switch or wireless switches 16 to the microcontroller 22 is transmitted via a radio frequency (RF) signal that is generated by a transmitter located within the housing 32 of the wireless switch 16.

In one embodiment, the latch 10 is a vehicle door latch and the vehicle door latch is part of a system comprising a microcontroller 22 configured to wirelessly receive the data from the wireless switch or wireless switches 16. Still further, the system or vehicle system may comprise a plurality of vehicle door latches 10 each of which are configured to wirelessly transmit data to a microcontroller or microcontrollers 22 via a plurality of wireless switches 16 located within the plurality of vehicle door latches. It is also understood that latch 10 may comprise any other vehicle latch that could be wirelessly coupled to a microcontroller for example, a trunk latch, a hood latch, etc.

In one embodiment, each of the plurality of wireless switches 16 include a housing 32 that is completely isolated from any electrical traces or alternatively, the latch 10 does not include any electrical traces as they are eliminated through the incorporation of the wireless switches 16. By eliminating the electrical traces in the latch 10 not only are the construction costs of the latch 10 reduced, the likelihood of a failure of the system through a short-circuit of one of the electrical traces located within the housing 12 is eliminated as they are no longer included within the housing.

Accordingly, a method and apparatus for wirelessly transmitting the operational state of a plurality of components of a latch for a vehicle is provided. In one embodiment, the method is facilitated by locating a plurality of wireless switches 16 within a housing 12 of the latch 10 and each of the plurality of wireless switches 16 are located proximate to one of a plurality of components 36 movably received within the housing 12 of the latch 10 such that movement of any one of the plurality of components 36 from a first position to a second position will change the operational state of one of the plurality of wireless switches 16 by manipulating an actuation member 26 of the one of the plurality of wireless switches 10. The data is wirelessly transmitted only from the housing 12 when the operational state of one of the plurality of wireless switches is changed and wherein the power required to wirelessly transmit the data from housing is generated solely by manipulation of the actuation member 26 of one the plurality of wireless switches 16.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch for a vehicle, comprising:
a housing;
a wireless switch located within the housing, wherein the wireless switch is configured to only wirelessly transfer data from the housing, wherein the data corresponds to an operational state of the wireless switch, wherein the power required to wirelessly transfer the data from housing is generated solely by manipulation of an actuation member of the wireless switch; and
a component moveably mounted within the housing for movement between at least a first position and a second position, wherein movement of the component in the housing manipulates the actuation member of the wireless switch and thus changes the state of the wireless switch.

2. The latch as in claim 1, wherein the component is a fork bolt and the wireless switch is located proximate to the fork bolt such that movement of the fork bolt between a latched and unlatched state will manipulate the actuation member and change the state of the wireless switch.

3. The latch as in claim 1, wherein the component is a detent lever configured to cooperate with a fork bolt of the latch and the wireless switch is located proximate to the detent lever such that movement of the detent lever between an engaged position and disengaged position with respect to the fork bolt will manipulate the actuation member and change the state of the wireless switch.

4. The latch as in claim 1, wherein the component is a child safety lever configured to prevent the latch from being opened by an inside release lever associated with the latch and the wireless switch is located proximate to the child safety lever such that movement of the child safety lever between an engaged position and disengaged position will manipulate the actuation member and change the state of the wireless switch.

5. The latch as in claim 1, wherein the component is a locking member configured to lock and unlock the latch and the wireless switch is located proximate to the locking member such that movement of the locking member will manipulate the actuation member and change the state of the wireless switch.

6. The latch as in claim 1, wherein the data is transmitted by RF signals generated within a housing of the wireless switch.

7. The latch as in claim 1, wherein the latch is a vehicle door latch and the vehicle door latch is part of a system comprising a microcontroller configured to wirelessly receive the data from the wireless switch.

8. The latch as in claim 1, wherein the latch is a trunk latch and the trunk latch is part of a system comprising a microcontroller configured to wirelessly receive the data from the wireless switch.

9. The latch as in claim 1, wherein the wireless switch has a housing completely isolated from any electrical traces.

10. The latch as in claim 1, further comprising:
a second wireless switch located within the housing, the second wireless switch being configured to only wirelessly transfer data from the housing, wherein the data corresponds to an operational state of the second wireless switch, wherein the power required to wirelessly transfer the data of the second wireless switch from housing is generated solely by manipulation of an actuation member of the second wireless switch; and
a second component moveably mounted within the housing for movement between at least a first position and a second position, wherein movement of the second component in the housing manipulates the actuation member of the second wireless switch and thus changes the state of the second wireless switch.

11. The latch as in claim 10, wherein the component is a fork bolt and the wireless switch is located proximate to the fork bolt such that movement of the fork bolt between a latched and unlatched state will manipulate the actuation member and change the state of the wireless switch and wherein the second component is a detent lever configured to cooperate with a fork bolt of the latch and the second wireless switch is located proximate to the detent lever such that movement of the detent lever between an engaged position and disengaged position with respect to the fork bolt will manipulate the actuation member of the second wireless switch and change the state of the second wireless switch.

12. The latch as in claim 11, further comprising:
a third wireless switch located within the housing, the third wireless switch being configured to only wirelessly transfer data from the housing, wherein the data corresponds to an operational state of the third wireless switch, wherein the power required to wirelessly transfer the data of the third wireless switch from housing is generated solely by manipulation of an actuation member of the third wireless switch; and
a third component moveably mounted within the housing for movement between at least a first position and a second position, wherein movement of the third component in the housing manipulates the actuation member of the third wireless switch and thus changes the state of the third wireless switch.

13. The latch as in claim 12, wherein the third component is a child safety lever configured to prevent the latch from being opened by an inside release lever associated with the latch and the third wireless switch is located proximate to the child safety lever such that movement of the child safety lever between an engaged position and disengaged position will manipulate the actuation member of the third wireless switch and change the state of the third wireless switch.

14. The latch as in claim 12, wherein the third component is a locking member configured to lock and unlock the latch and the third wireless switch is located proximate to the locking member such that movement of the locking member will manipulate the actuation member of the third wireless switch and change the state of the third wireless switch.

15. The latch as in claim 14, wherein the data is transmitted by RF signals generated within a housing of the wireless switch, the second wireless switch and the third wireless switch.

16. The latch as in claim 15, wherein the latch is a vehicle door latch and the vehicle door latch is part of a system comprising a microcontroller configured to wirelessly receive the data from the wireless switch, the second wireless switch and the third wireless switch.

17. The latch as in claim 15, wherein the housing of the wireless switch, the second wireless switch and the third wireless switch are completely isolated from any electrical traces.

18. A latch for a vehicle, comprising:
a housing;
a plurality of wireless switches located within the housing, wherein each of the plurality of wireless switches are located within the housing and are configured to independently wirelessly transmit data from the housing, wherein the data corresponds to the state of the wireless switch transmitting the data;
wherein the power required to wirelessly transmit the data from housing is generated solely by manipulation of an actuation member of one the plurality of wireless switches; and
a plurality of components moveably mounted within the housing for movement between at least a first position and a second position, wherein movement of at least one of the plurality of components in the housing manipulates the actuation member of at least one of the plurality of wireless switches and thus changes its state and causes data to be wirelessly transmitted from the housing of latch.

19. The latch as in claim 18, wherein the latch is a vehicle door latch and the vehicle door latch is part of a system comprising at least one microcontroller configured to wirelessly receive the data from the plurality of wireless switches.

20. A method for wirelessly transmitting the operational state of a plurality of components of a latch for a vehicle, comprising:
locating a plurality of wireless switches within a housing of the latch, each of the plurality of wireless switches being proximate to one of a plurality of components movably received within a housing of the latch such that movement of any one of the plurality of components from a first position to a second position will change the operational state of one of the plurality of wireless switches by manipulating an actuation member of the one of the plurality of wireless switches; and
wirelessly transmitting only data from the housing when the operational state of one of the plurality of wireless switches is changed, wherein the power required to wirelessly transmit the data from housing is generated solely by manipulation of the actuation member of one the plurality of wireless switches.
